(19) United States
(12) Patent Application Publication
(10) Pub. No.: US 2023/0109888 A1
(43) Pub. Date: Apr. 13, 2023

(54) VALVE FOR SOFT RELEASE OF TRAPPED AIR AND FUNCTIONAL ASSEMBLY

(71) Applicant: TRIPLE WIN TECHNOLOGY(SHENZHEN) CO.LTD., Shenzhen (CN)

(72) Inventors: XIN-CHUN ZHANG, Zhengzhou (CN); CHING-HUANG LIN, Taoyuan (TW)

(21) Appl. No.: 17/683,247

(22) Filed: Feb. 28, 2022

(30) Foreign Application Priority Data
Oct. 13, 2021 (CN) 202111193829.4

(51) Int. Cl. F16K 15/14

(52) U.S. Cl. CPC F16K 15/1471

(57) ABSTRACT

An air pressure relief valve providing relief against both gradual and sudden changes in pressure is disposed on an opening of an assembly of parts. The valve includes a plurality of blades, the blades are circumferentially distributed and abut each other. Each blade includes a nozzle end, the nozzle ends abut each other, and a part of the nozzle end on each blade allows deformation by internal air pressure to form an air hole, wherein air can enter or exit the functional assembly through the air hole. The thickness of the blade gradually decreases in direction from a thick base end to the thinner-section air nozzle end.

### FIELD

The subject matter herein generally relates to manufacturing.

### BACKGROUND

When assembling electronic or other equipment, a step of pressing two parts together is often required. One part will be provided with an opening having an air valve. The air in or between the two parts is compressed and must be discharged during the pressing process, to avoid deformation or damage to the parts due to the increase of internal air pressure. The air valve is usually hemispherical and consists of a plurality of mutually butted blade petals. The outer arc surface of the air valve is the outside of the part, and the inner arc surface is on the inside of the part.

In the current air valve, when the pressure difference between the outside and inside air pressures reaches a threshold, the inside air can suddenly rush away through the air valve, and the sudden change in air pressure can easily lead to the damage of the part carrying the air valve, or to components within the assembly.

Therefore, improvement is desired.

### BRIEF DESCRIPTION OF THE DRAWINGS

Implementations of the present disclosure will now be described, by way of embodiments, with reference to the attached figures.

FIG. 1 is a schematic diagram of an embodiment of a functional assembly of the present disclosure.

FIG. 2 is a schematic diagram of an embodiment of an exhaust valve of the present disclosure.

FIG. 3A is a cross-sectional view of an embodiment of the exhaust valve of the present disclosure.

FIG. 3B is a cross-sectional view of another embodiment of the exhaust valve of the present disclosure.

FIG. 4A is a schematic diagram of another embodiment of an exhaust valve of the present disclosure.

FIG. 4B is a cross-sectional view of the exhaust valve of FIG. 4A.

FIG. 5 is a cross-sectional view of an exhaust valve of the present disclosure.

FIG. 6 is a cross-sectional view of another embodiment of an exhaust valve of the present disclosure.

FIG. 7A is a schematic diagram of an inner side of a blade of the exhaust valve of the present disclosure.

FIG. 7B is a schematic diagram of an outer side of a blade of the exhaust valve of the present disclosure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

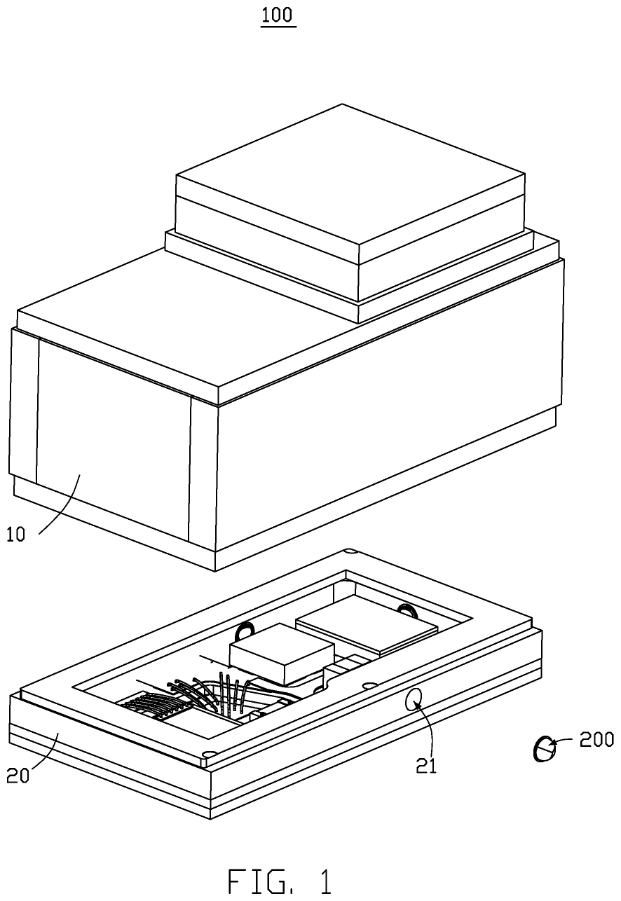

FIG. 1 illustrates a functional assembly 10 in accordance with an embodiment of the present disclosure. The functional assembly 10 may be a pressed-together assembly on an electronic device (not shown). The functional assembly 10 is hollow, and the functional assembly 10 defines an opening 21. The functional assembly 10 includes a first component 10 and a second component 20. The first component 10 can be pressed together with the second component 20 to form the functional assembly 10. The opening 21 allows the gas inside the functional assembly 10 to escape out of the functional assembly 10 during the pressing-together process of joining the first component 10 and the second component 20.

For example, the functional assembly 10 can be a camera assembly applied in an electronic device, the first component 10 can be a collimator, the second component 20 can be a base, and the first component 10 is arranged on the second component 20 and bonded with the second component 20.

In one embodiment, the opening 21 is on the first component 10. In another embodiment, the opening 21 is on the second component 20. In another embodiment, the opening 21 is at the connection between the first component 10 and the second component 20, not limited in the present disclosure.

In the embodiment, the opening 21 is provided with an exhaust valve 20, the exhaust valve 20 is a one-way valve.

When an air pressure difference between the inside of the functional assembly 10 and the outside of the functional assembly 10 reaches a first threshold, the exhaust valve 20 is opened by air pressure in the functional assembly 10, and excess air pressure in the functional assembly 10 can be discharged from the functional assembly 10.

When the air pressure difference reaches a second threshold, the exhaust valve 20 is opened by the air pressure outside of the functional assembly 10, and the gas outside the functional assembly 10 can enter into the functional assembly 10 to relieve the difference, the first threshold is less than the second threshold.

Sudden changes of air pressure in the functional assembly 10 can lead to the damage of the functional assembly 10 and its components.

In order to solve the above problems, the embodiment of the present disclosure provides an exhaust valve, the present disclosure improves the structural strength of the exhaust valve without affecting the ventilation function of the exhaust valve. Sudden changes of air pressure in the functional assembly 10 are avoided and thus the probability of damage of the functional assembly 10 due to the sudden change of internal air pressure is reduced.

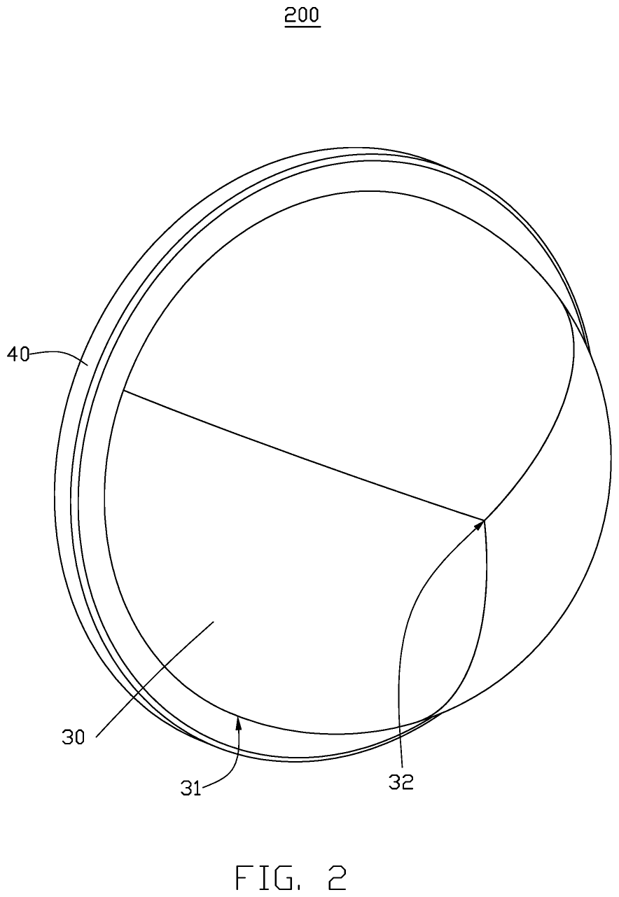

FIG. 2 illustrates an exhaust valve 20 in accordance with an embodiment of the present disclosure.

In the embodiment, the exhaust valve 20 is disposed on the opening 21, the exhaust valve 20 includes a plurality of blades 30. The blade 30 is triangular. In one exhaust valve 20, the blades 30 are circumferentially distributed and butted with each other, the side wall of one blade 30 abuts the side wall of another blade 30. The two ends of the blade 30 are a base end 31 and a nozzle end 32 respectively. The base end 31 connects to the functional assembly 10. A plurality of the nozzle ends 32 abut against each other, and the thickness of each blade 30 gradually increases from the nozzle end 32 to the base end 31.

The base ends 31 of the exhaust valve 20 are located on the same plane, the connection points of the nozzle ends 32 are on a raised and different plane, and the exhaust valve 20 is an exhaust valve protruding from the middle to one side.

It can be understood that the shape of the exhaust valve 20 can be, but is not limited to, conical or hemispherical.

It can be understood that the blade 30 is made of elastic material, which can be, but is not limited to, linear low density polyethylene (LLDPE).

For example, the exhaust valve 20 is hemispherical, and the outer arc surface of the exhaust valve 20 and the blade 30 is the outside of the functional assembly 10. The inner arc surface of the exhaust valve 20 and the blade 30 is the inside of the functional assembly 10, the inside of the exhaust valve 20 is the interior of the hollow part of the functional assembly 10.

It can be understood that the exhaust valve 20 forms a one-way valve, and its resistance to the air pressure outside the functional assembly 10 is greater than its resistance to the air pressure inside of the functional assembly 10. The air in the functional assembly 10 can be discharged from the functional assembly 10, reducing air pressure in the functional assembly 10 is easier than allowing the entry of a higher air pressure from outside of the functional assembly 10.

The thickness of the blade 30 gradually increases from the nozzle end 32 to the base end 31, so that the thickness of the nozzle end 32 is the smallest, and the thickness of the base end 31 is the largest. The base end 31 is the end with the greatest structural strength, the nozzle end 32 is the end with the lowest structural strength, the nozzle end 32 is most prone to deformation. The base end 31 is the most difficult to deform, even when the air pressure difference between the inner and outer sides of the functional assembly 10 reaches the threshold. Sudden changes of air pressure in the functional assembly 10 are thus relieved, and the probability of damage of the functional assembly 10 due to the sudden change of internal air pressure is reduced.

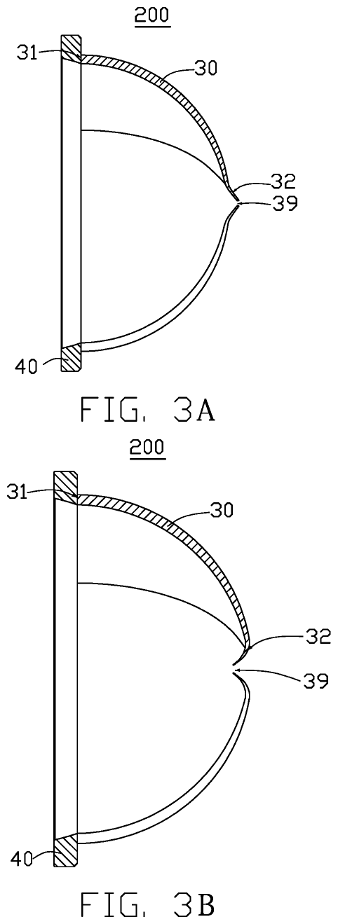

Referring to FIG. 3A, for example, when the difference between the higher air pressure inside the functional assembly 10 and the air pressure outside the functional assembly 10 reaches the first threshold, the part of the blade 30 close to the nozzle end 32 bends outward to form an air hole 39 communicating with the hollow part in the functional assembly 10. At this time, the air in the functional assembly 10 is exhausted to the outside of the exhaust valve 20 through the air hole 39. As the difference between the air pressure inside the functional assembly 10 and the higher air pressure outside the functional assembly 10 increases, the part on the blade 30 between the nozzle end 32 and the base end 31 deforms, and the bending part of the blade 30 gradually approaches the base end 31.

Referring to FIG. 3B, for example, when the difference between the air pressure outside the functional assembly 10 and the air pressure inside the functional assembly 10 reaches the second threshold, the part of the blade 30 close to the nozzle end 32 bends inward and deforms to form the air hole 39 communicating with the hollow part in the functional assembly 10. At this time, a part of the air outside the exhaust valve 20 enters into the functional assembly 10 through the air hole 39. As the difference between the higher air pressure outside the functional assembly 10 and the air pressure inside the functional assembly 10 increases, the part on the blade 30 between the nozzle end 32 and the base end 31 deforms, and the bending part on the blade 30 gradually approaches the base end 31.

The thickness of the blade 30 decreases continuously from the base end 31 to the nozzle end 32. In one embodiment, the change in thickness of the blade 30 is continuous. In another embodiment, the change in thickness of the blade 30 is stepped or phased. The blade 30 can be divided into multiple parts in the direction of the base end 31 extending to the nozzle end 32. As between the blades 30, the thickness of parts of the same elevation is the same, and the thickness of parts on different elevations is different.

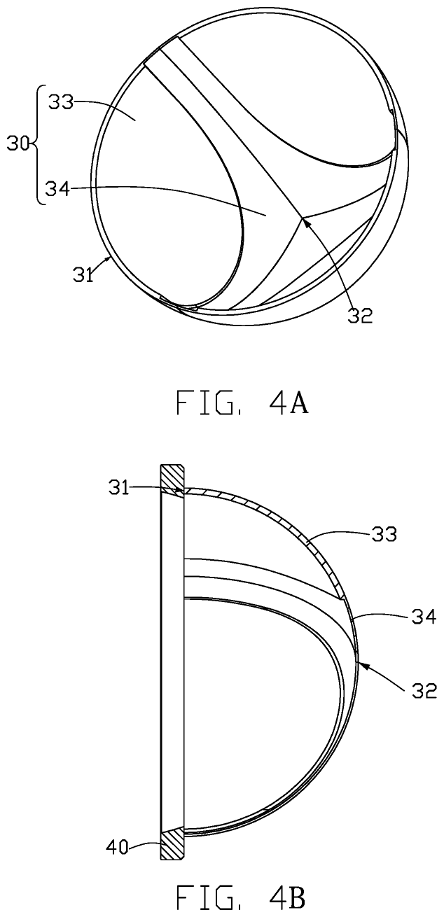

Referring to FIG. 4A and FIG. 4B, in one embodiment, the blade 30 may include a nozzle portion 34 and a base portion 33. The thickness of each part of the base portion 33 is the same, and the thickness of each part of the nozzle portion 34 is the same. The thickness of the base portion 33 is greater than that of the nozzle portion 34, one end of the base portion 33 is integrally connected with one end of the nozzle portion 34. The base end 31 is the end of the base portion 33 away from the nozzle portion 34, and the nozzle end 32 is the end of the nozzle portion 34 away from the base portion 33.

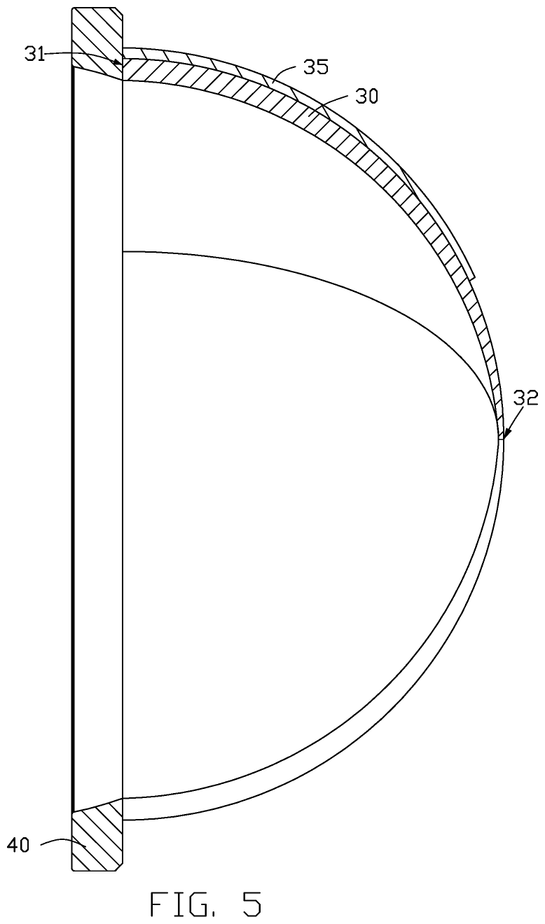

Referring to FIG. 5, in another embodiment, a rib 35 protrudes from the blade 30, the rib 35 is arranged in the extension direction from the base end 31 to the nozzle end 32. The rib 35 can reduce the sudden change of air pressure in the functional assembly 10 after reducing the air pressure difference between the inside and outside of the functional assembly 10 to the threshold.

In one embodiment, the rib 35 is arranged on the outer surface of the exhaust valve 20. In another embodiment, the rib 35 is arranged on the inner surface of the exhaust valve 20, not being limited.

In one embodiment, the length of the rib 35 is equal to the shortest distance between the nozzle end 32 and the base end 31. In another embodiment, the length of the rib 35 is less than the shortest distance between the nozzle end 32 and the base end 31. The embodiments of the present disclosure do not limit the length of the rib 35.

In one embodiment, the thickness of the rib 35 varies with the thickness of the blade 30. The thickness of the rib 35 gradually decreases in the direction from the base end 31 to the nozzle end 32. In another embodiment, the thickness of the rib 35 is constant throughout its length. For example, the rib 35 and the blade 30 are integrally connected to the outer surface of the blade 30, and one end of the rib 35 is flat with the base end 31. The length of the rib 35 is less than the shortest distance between the base end 31 and the nozzle end 32, and the thickness of each part of the rib 35 is the same.

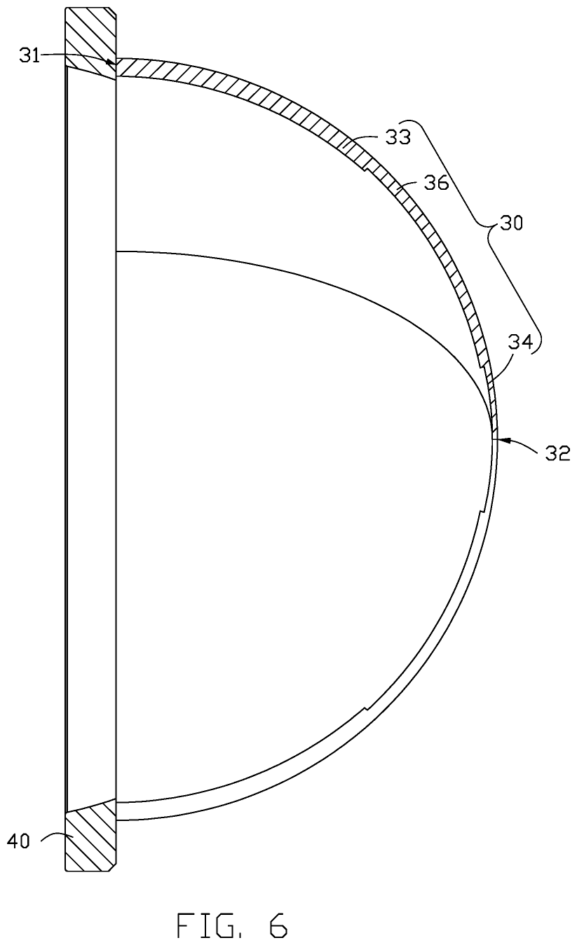

Referring to FIG. 6, in one embodiment, the blade 30 may include the nozzle portion 34, the base portion 33, and the connecting portion 36. The base portion 33, the connecting portion 36, and the nozzle portion 34 are arranged in order. The ends of the connecting portion 36 are integrally connected with the nozzle portion 34 and the base portion 33. The thickness of each part of the base portion 33 is the same, the thickness of each part of the nozzle portion 34 is the same, and the thickness of each part of the connecting portion 36 is the same. The thickness of the connecting portion 36 is less than the thickness of the base portion 33, and greater than the thickness of the nozzle portion 34.

It can be understood that the nozzle portion 34, the base portion 33, and the connecting portion 36 can be injection molded.

For example, the thickness of the nozzle portion 34 is 0.02 mm, the thickness of the connecting portion 36 is 0.06 mm, and the thickness of the base portion 33 is 0.1 mm.

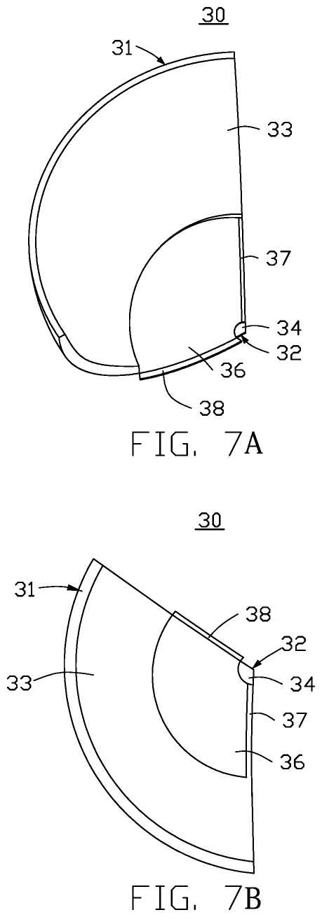

Referring to FIG. 7A and FIG. 7B, in one embodiment, the outer surfaces of the connecting portion 36, the base portion 33, and the nozzle portion 34 are continuous outer surfaces. A first extending portion 37 extends from one end of the base portion 33 away from the base end 31, and the first extending portion 37 is integrally connected with the nozzle portion 34. The outer surface of the first extending portion 37 is continuous with the outer surface of the base end 31, and the thickness of the first extending portion 37 is less than that of the connecting portion 36. One side of the first extending portion 37 is connected to one side of the connecting portion 36, and another side of the first extending portion 37 abuts the side wall of the base portion 33 on the other blade 30. The side of the connecting portion 36 away from the first extending portion 37 is flat against the side of the base portion 33 and the nozzle portion 34. A second extending portion 38 extends on one side of the connecting portion 36 away from the first extending portion 37, and the inner surface of the second extending portion 38 is continuous with the inner surface of the connecting portion 36. The thickness of the second extending portion 38 is less than that of the connecting portion 36, and the second extending portion 38 is supported on the inner surface of the first extending portion 37 on the other blade 30.

In this embodiment, the sum of the thicknesses of the first extending portion 37 and the second extending portion 38 is nearly equal to the thickness of the connecting portion 36.

The abutted disposition of the second extending portion 38 and the first extending portion 37 strengthens the connection strength between each blade 30, improves the structural strength of the connecting portion 36, and makes it more difficult for the connecting portion 36 to deform under a pressure difference.

When the air pressure difference between both sides of the functional assembly 10 reaches a threshold, the nozzle portion 34 deforms to form an air hole 39 for air to pass through. At this time, the size of the air hole 39 is small, avoiding the rapid change of air pressure by an outrush of air from the functional assembly 10.

In one embodiment, the thickness of the nozzle portion 34 is equal to the thickness of the first extending portion 37.

As shown in FIG. 2, in some embodiment, the exhaust valve 20 may also include a base body 40, the base body 40 is annular. The base body 40 is sleeved on the base end 31 of the blade 30, and fixedly connected with the base end 31. The base body 40 is fixedly installed on the functional assembly 10.

It can be understood that the fixed connection form between the base body 40 and the base end 31 can be, but is not limited to, adhesive fixation and integrated fixation.

For example, the base body 40 is integrally fixed with the base end 31, and the base body 40 and the base end 31 are formed by injection molding of the same material.

It can be understood that the base body 40 is arranged at the opening 21, and the base body 40 can be bonded and fixed with the inner surface of the functional assembly 10 to form the opening 21.

The following describes the implementation principle of the exhaust valve 20.

When the difference between the higher air pressure inside functional assembly 10 and the air pressure outside the functional assembly 10 reaches the first threshold, the nozzle portion 34 turns outward and deforms to form the air hole 39, and air in the functional assembly 10 is released from the functional assembly 10.

When the difference between the higher air pressure inside functional assembly 10 and the air pressure outside the functional assembly 10 reaches a second threshold, and the second threshold is greater than the first threshold, the connecting portion 36, the first extending portion 37 and the second extending portion 38 are deformed and turn outward, the air hole 39 expands, and the air in the functional assembly 10 can be released from the functional assembly 10 more quickly.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will, therefore, be appreciated that the exemplary embodiments described above may be modified within the scope of the claims.

What is claimed is:

1. An exhaust valve disposed on an opening of an assembly, and comprising:
a plurality of blades circumferentially distributed and butted against each other; wherein each of the plurality of blades comprises a nozzle end, each of the nozzle ends is butted with each other, and a part of the blade near the nozzle end is configured for deformation to form an air hole; and
wherein air enters or exits the functional assembly through the air hole, and a thickness of each of the plurality of blades gradually decreases in a direction from a base end away from the nozzle end to the air nozzle end.

2. The exhaust valve according to claim 1, wherein an rib is disposed on one side of each of the blades, and the rib extends along opposite direction of both ends of each of the blades.

3. The exhaust valve according to claim 2, wherein a thickness of the rib gradually decreases in direction from a base end away from the nozzle end to the nozzle end.

4. The exhaust valve according to claim 1, wherein each of the plurality of blades comprises a base portion, a nozzle portion, and a connecting portion, a first end of the connecting portion is connected to the base portion, a second end of the connecting portion is connected to the nozzle portion, the nozzle end is located at an end of the nozzle portion away from the connecting portion.

5. The exhaust valve according to claim 4, wherein a thickness of the base portion is greater than a thickness of the connecting portion, and a thickness of the nozzle portion is less than the thickness of the connecting portion.

6. The exhaust valve according to claim 5, wherein a first extending portion is connected between the base portion and the nozzle portion, and a thickness of the first extending portion is less than the thickness of the base portion, a first side of the first extending portion is connected to a side of the connecting portion, and a second side of the first extending portion is butted with the side of the connecting portion of another one of the plurality of the blades.

7. The exhaust valve according to claim 6, wherein a side of the connecting portion away from the first extending portion is connected to a second extending portion.

8. The exhaust valve according to claim 7, wherein a thickness of the second extending portion is less than the thickness of the connecting portion, the second extending portion is butted with the second extending portion of another one of the plurality of the blades.

9. The exhaust valve according to claim 8, wherein a sum of the thicknesses of the first extending portion and the second extending portion is equal to the thickness of the connecting portion.

10. The exhaust valve according to claim 1, wherein the exhaust valve further comprises a base body, the base body is connected to one end of the plurality of the blades away from the nozzle end.

11. An assembly comprising:
a first component defining an opening; and
an exhaust valve disposing on the opening;
wherein the exhaust valve comprises a plurality blades circumferentially distributed and butted against each other; wherein each of the plurality of blades comprises a nozzle end, a plurality of the nozzle ends is butted with each other, and a part of the blade near the nozzle end is configured for deformation to form an air hole; and
wherein air enters or exits the assembly through the air hole, and a thickness of each of the plurality of blades gradually decreases in direction from a base end away from the nozzle end to the air nozzle end.

12. The functional assembly according to claim 11, wherein an rib is disposed on one side of each of the blades, and the rib extends along opposite direction of both ends of the blade.

13. The functional assembly according to claim 12, wherein a thickness of the rib gradually decreases in direction from a base end away from the nozzle end to the nozzle end.

14. The functional assembly according to claim 11, wherein each of the plurality of blades comprises a base portion, a nozzle portion, and a connecting portion, a first end of the connecting portion is connected to the base portion, a second end of the connecting portion is connected to the nozzle portion, the nozzle end is located at an end of the nozzle portion away from the connecting portion.

15. The functional assembly according to claim 14, wherein a thickness of the base portion is greater than a thickness of the connecting portion, and a thickness of the nozzle portion is less than the thickness of the connecting portion.

16. The functional assembly according to claim 15, wherein a first extending portion is connected between the base portion and the nozzle portion, and a thickness of the first extending portion is less than the thickness of the base portion, a first side of the first extending portion is connected to a side of the connecting portion, and a second side of the first extending portion is butted with the side of the connecting portion of another one of the plurality of the blades.

17. The functional assembly according to claim 16, wherein a side of the connecting portion away from the first extending portion is connected to a second extending portion.

18. The functional assembly according to claim 17, wherein a thickness of the second extending portion is less than the thickness of the connecting portion, the second extending portion is butted with the second extending portion of another one of the plurality of the blades.

19. The functional assembly according to claim 18, wherein a sum of the thicknesses of the first extending portion and the second extending portion is equal to the thickness of the connecting portion.

20. The functional assembly according to claim 11, wherein the exhaust valve further comprises a base body, the base body is connected to one end of the plurality of the blades away from the nozzle end.
